(19) United States
(12) Patent Application Publication
(10) Pub. No.: US 2011/0076116 A1
(43) Pub. Date: Mar. 31, 2011

(54) SOLID FUEL CONVEYANCE AND INJECTION SYSTEM FOR A GASIFIER

(75) Inventors: Ke Liu, Rancho Santa Margarita, CA (US); Zhe Cui, Fountain Valley, CA (US); Wei Chen, Shanghai (CN); Mingmin Wang, Shanghai (CN)

(73) Assignee: GENERAL ELECTRIC COMPANY, SCHENECTADY, NY (US)

(21) Appl. No.: 12/569,263

(22) Filed: Sep. 29, 2009

(51) Int. Cl. B66C 17/08

(52) U.S. Cl. 414/160

(57) ABSTRACT

A system for use in a gasification system, comprises a solid pump that delivers a pressurized fuel and a high-pressure transition vessel. The transition vessel comprises a first inlet connected to an outlet of the solid pump so that all of the fuel from the solid pump passes through the transition vessel, a second inlet for connection to a conveyance gas line, and an outlet through which the fuel is transported to a gasifier. The transition vessel is elongated in the direction of a flow so that a conveyance gas introduced through said conveyance gas line plus the pressure difference carries the fuel to the gasifier.

### BACKGROUND

The invention relates generally to solid fuel (coal, biomass, pet coke and waste, etc) gasification systems, more particularly, to a system for conveying and injecting solid particulate fuel to a gasifier, especially a high-pressure gasifier.

Currently, both slurry feeding and dry feeding technologies are commercially utilized in coal gasification systems. Some gasifiers use coal-water slurry for fuel feed, but for the high-moisture content low-rank coal, the slurry feed may not work or the efficiency is too low due to too much water introduced into the gasifier. In this case, a dry feed system is employed. In some dry feed systems, low rank coals may be dried to remove two-thirds, or more, of the inherent moisture present in the coal. This improves the flow characteristics of the solids in the dry feed system equipment and the overall efficiency of the gasifier. However, the overall power production of the plant maybe reduced since the drying process consumes a large amount of energy. In addition, the dry feed system equipment, which may include a compressor, lock hoppers, lock hopper valves, drying equipment and additional storage capacity, results in a relatively expensive system when compared with slurry-based systems.

Other fuel feed systems (such as the systems described in U.S. Patent Application No. US20090107046) pressurize and convey high moisture content solid fuel such as coal to the gasifier using solid pumps and moisture removal systems. Solid fuel (e.g. coal) is grinded to a predetermined size and the moisture content within the particulate fuel is adjusted. The fuel is conveyed through a buffer vessel or directly to an injector of gasifier. The solid pumps on upstream of the gasifier facilitate pressurizing the coal from atmospheric pressure at the pump inlet to a pressure above the gasifier operating pressure in order to facilitate pneumatic conveyance of the coal into the gasifier.

However, due to the long distance pipeline conveyance, the stability of the solid flow injected into a gasifier is questionable. Also, the solid pump cannot be used as a metering instrument for solid injected into the gasifier in this configuration due to the large buffer tank. Furthermore, solid fuel is injected into a gasifier along with slag additives and recycled fines, which may lead to decreased mixing and carbon conversion. It would therefore be desirable to provide stable transportation of solid fuel to a gasifier and enhance carbon conversion.

### BRIEF DESCRIPTION

In accordance with one embodiment disclosed herein, a system for use in a gasification system, comprises a solid pump that delivers a pressurized fuel and a high-pressure transition vessel. The transition vessel comprises a first inlet connected to an outlet of the solid pump so that all of the fuel from the solid pump passes through the transition vessel, a second inlet for connection to a conveyance gas line, and an outlet through which the fuel is transported to a gasifier. The transition vessel is elongated in the direction of a flow so that a conveyance gas introduced through said conveyance gas line carries the fuel to the gasifier.

In accordance with another embodiment disclosed herein, a system for use in a gasification system, comprises a plurality of solid pumps that deliver a pressurized solid particulate fuel and a high-pressure transition vessel. The transition vessel comprises a plurality of first inlets, a second inlet for connection to a conveyance gas line, and an outlet through which the fuel is transported to an injection system of a gasifier. Each of the first inlets is connected to an outlet of the solid pump so that all of the solid particulate fuel from the solid pumps passes through the transition vessel. The transition vessel is elongated in the direction of a flow so that a conveyance gas introduced through said conveyance gas line carries the fuel to the injection system.

In accordance with another embodiment disclosed herein, a system for use in a gasification system, comprises an injection system for a gasifier, a plurality of solid pumps that deliver a pressurized solid particulate fuel, and a high-pressure transition vessel. The injection system comprises a slurry injector and a plurality of feed injectors. The transition vessel comprises a plurality of first inlets, a second inlet for direct connection to a conveyance gas line, and an outlet through which the fuel is transported to the feed injectors. Each of the first inlets is connected directly to an outlet of the solid pump so that all of the solid particulate fuel from the solid pumps passes through the transition vessel. The transition vessel is elongated in the direction of a flow so that a conveyance gas introduced through said conveyance gas line carries the fuel to the feed injectors.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of a system for transporting and injecting fuel in accordance with aspects disclosed herein.

FIG. 2 illustrates a cross-sectional view of a gasifier with the injection system in accordance with aspects disclosed herein.

FIG. 3 illustrates a partial view of FIG. 2 showing a feed injector in accordance with aspects disclosed herein.

FIG. 4 illustrates another embodiment of a system for transporting and injecting fuel with an auxiliary transition vessel in accordance with aspects disclosed herein.

FIG. 5 illustrates another embodiment of a system for transporting and injecting fuel where the transition unit is directly connected to the injector in accordance with aspects disclosed herein.

FIG. 6 illustrates another embodiment of a system for transporting and injecting fuel where the transition unit is connected to a feeder in accordance with aspects disclosed herein.

### DETAILED DESCRIPTION

Embodiments disclosed herein include a system for transporting and injecting fuel from a solid pump to a gasifier. The system mainly includes a high-pressure transition vessel and an injection system. The transition vessel includes inlets for connection to a solid pump and a conveyance gas line and an outlet through which fuel is transported to the injection system. The injection system includes a slurry injector and a plurality of feed injectors that are connected to the outlet of the transition vessel. As used herein, singular forms such as “a,” “an,” and “the” include plural referents unless the context clearly dictates otherwise.

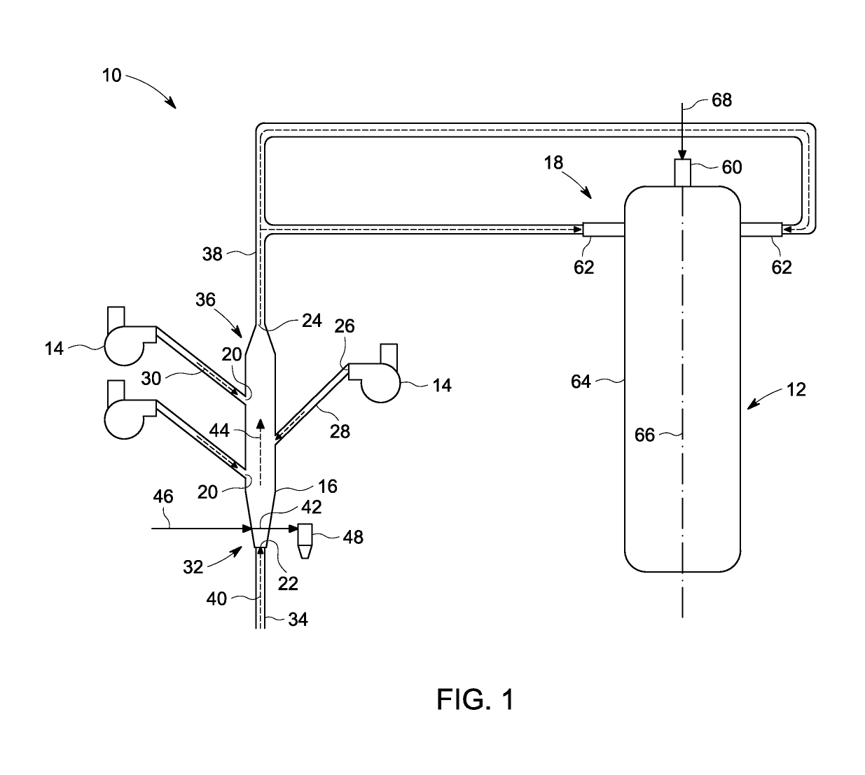

FIG. 1 illustrates an embodiment of the system 10 for transporting and injecting fuel to a gasifier 12. The system 10 includes solid pumps 14, a high-pressure transition vessel 16, and an injection system 18. The system 10 is used in a gasification system using solid particulate fuel. In one embodiment, solids pumps 14 are rotary, converging space Solids Transport and Metering pump utilizing Stamet™ Posimetric® feed technology, otherwise known as a Stamet™ solids pump commercially available from GE Energy, Atlanta, Ga. This pump is capable of transporting solids from atmospheric pressure to pressures well over 1000 psig with a strongly linear relationship between pump rotational speed and solids mass flow.

The transition vessel 16 includes first inlets 20, a second inlet 22, and an outlet 24. The first inlets 20 are located on the sidewall of the transition vessel 16. The outlets 26 of solid pumps 14 are directly connected to the first inlets 20 using declining pipelines 28 so that all of the solid particulate fuel 30 delivered by the solid pumps 14 pass through the transition vessel 16. In one embodiment, the first inlets 20 are at different levels of the transition vessel 16 to enable connection of multiple solid pumps 14. The second inlet 22 is at the bottom 32 of the transition vessel 16 and is connected to a conveyance gas line 34. The outlet 24 is at the top portion 36 of the transition vessel 16. An outlet pipeline 38 connects the outlet 24 to the injection system 18.

The transition vessel 16 is a high-pressure vessel, having an operating range of about 500 psi to about 1000 psi. Solid particulate fuels including, but not limited to, coal, biomass, pet coke, and mixtures thereof, are pressurized by the solid pump 14 and fed into the transition vessel 16 through the pipeline 28. The conveyance gas 40 enters the transition vessel 16 from the second inlet 22 and carries the solid particulate fuel 30 to the injection system 18 through the outlet pipeline 38. In one embodiment, the system 10 further includes a distributor 42 or nozzles (not shown) in the transition vessel 16 to distribute the conveyance gas 40 for carrying the solid particulate fuel 30 to the outlet pipeline 38.

The transition vessel 16 is slim and elongated in configuration in the direction of the flow 44 of the conveyance gas 40 through the transition vessel 16 so that the superficial velocity of the conveyance gas 40 is high enough to carry all solid fuel particles 30 to the outlet pipeline 38 immediately after the fuel 30 enters the transition vessel 16. The transition vessel 16 provides “transition” in that all the solid particulate fuel 30 has to transition or pass through the transition vessel 16 before entering the gasifier 12. Transition through the vessel 16 alters or adjusts pressure conditions of the solid particulate fuel 30 to enable smooth delivery to the injection system 18. The solid fuel particles 30 from the solid pump 14 are transported stably and smoothly to the injection system 18 compared to traditional feeder vessel (not shown), eliminating negative effects such as block, plug-in, and rat holing. The transition vessel 16 can be installed on the ground or at the top of the gasifier 12 according to the field conditions.

The solid flow in the transition unit and the conveyance line is operated under transport flow regime. Therefore, the residence time of the solid particles in the transition unit can be minimized to several minutes. The volume of the transition unit is thus significantly smaller than the buffer tank used in current gasification systems, normally in the range of about 30 minutes to about two hours of residence time.

The system 10 further comprises a purge gas line 46 and a discharge hopper 48. The purge gas line 46 is in flow communication with the distributor 42 and the discharge hopper 48. Solid particulate fuel that is not delivered by the conveyance gas 40 will settle in the distributor 42. A purge gas is introduced in the transition vessel through the purge gas line 46 to clear the distributor 42. The purge gas transfers undelivered fuel from the distributor 42 to the discharge hopper 48. The fuel collected in the discharge hopper 48 can be cleared periodically.

In one embodiment, the injection system 18 includes a slurry injector 60 and a plurality of feed injectors 62. Recycled fines and slag additives 68 are made into slurry and injected into the gasifier 12 via the slurry injector 60. The outlet pipeline 38 from the transition vessel 16 is connected to the feed injectors 62. The solid particulate fuel 30 is delivered to the gasifier through the feed injectors 62. The slurry injector 60 is installed on top of the gasifier 12 and the feed injectors 62 are installed on the sidewall 64 of the gasifier 12. The feed injectors 62 are installed symmetrically around the gasifier 12, i.e. the feed injectors are installed symmetrically with respect to a central axis 66 of the gasifier 12. Injectors 62 can be installed horizontally or with some angles for different feedstock with different reactivity.

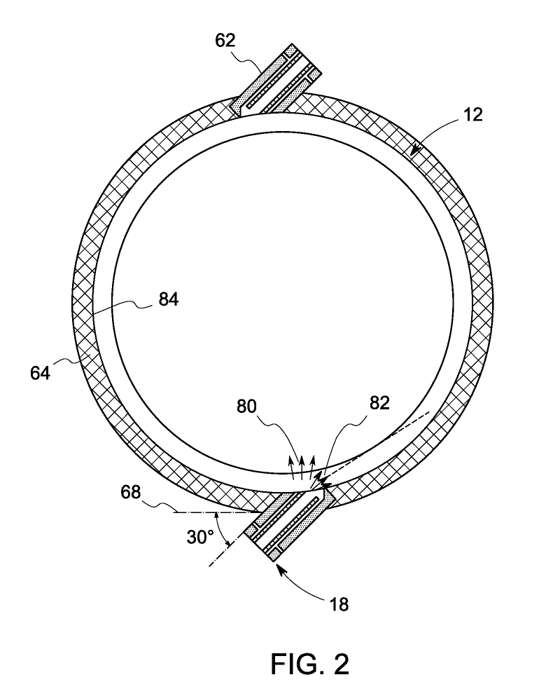

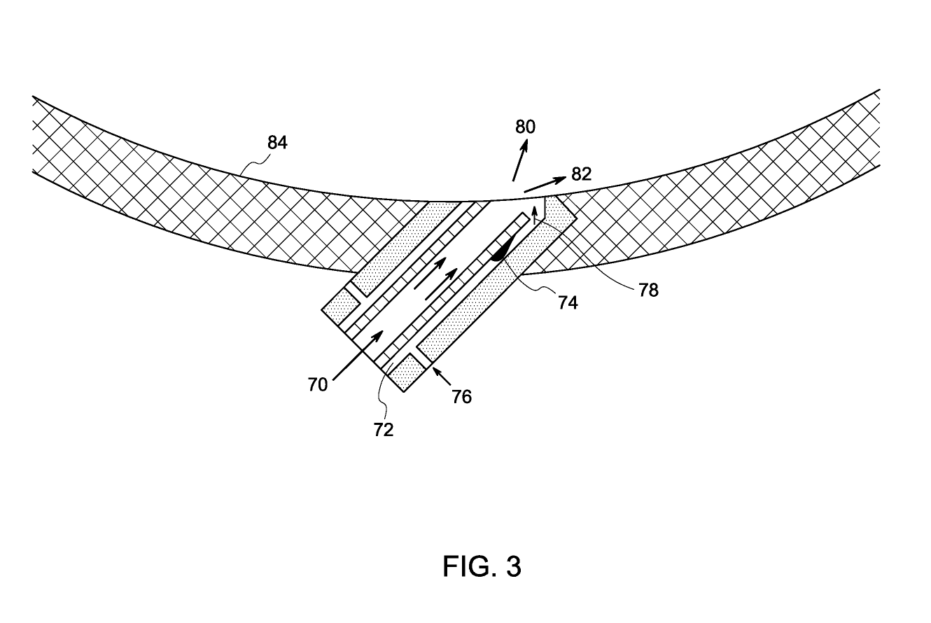

Referring to FIGS. 2 and 3, the solid feed injectors 62 are installed at an oblique angle with respect to the sidewall 64 of the gasifier 12. In one embodiment, the oblique angle is less than 30 degrees with respect to a tangential direction 68 of the sidewall 64. In another embodiment (not shown), the feed injectors are perpendicular to the sidewall of the gasifier. The feed injector 62 includes a central channel 70 for conveying the solid particulate fuel 30 and a swirl channel 72 concentric with the central channel 70. The swirl channel 72 includes swirlers 74 to generate swirl gas. Solid particulate fuel 30 is injected through the central channel 70 along with a conveyance gas 40, such as, for example, Nitrogen or Carbon dioxide, that carries the solid particulate fuel 30. Gasification agents 76 such as Oxygen or steam are injected through the swirl channel 72 to generate a swirl gas 78. The symmetrical arrangement of the feed injectors 62 around the gasifier 12 generates a uniform flow field in the gasifier 12.

Due to the effect of the swirl gas 78 from the feed injector 62, fuel particles with different hydrodynamics characteristics will be separated in the spray. Smaller fuel particles 80 or particles with lower density will be sprayed into the bulk gas phase of the gasifier 12 due to the effect of the swirl gas 78. But the direction of larger fuel particles 82 or particles with higher density will not be impacted. Larger fuel particles 82 will follow original streamline and attach onto slag on the inner surface 84 of the gasifier 12. Smaller fuel particles 80 that need short residence time in the gasifier 12 will be gasified in the bulk gas phase. Larger fuel particles 82 that need longer residence time for higher carbon conversion will flow down with slag and react for a longer time.

The injection system 18 therefore takes advantage of the hydrodynamics difference between larger 82 and smaller 80 particles to achieve different residence time for different particles. The carbon conversion will be increased and the amount of recycled fines can be significantly reduced.

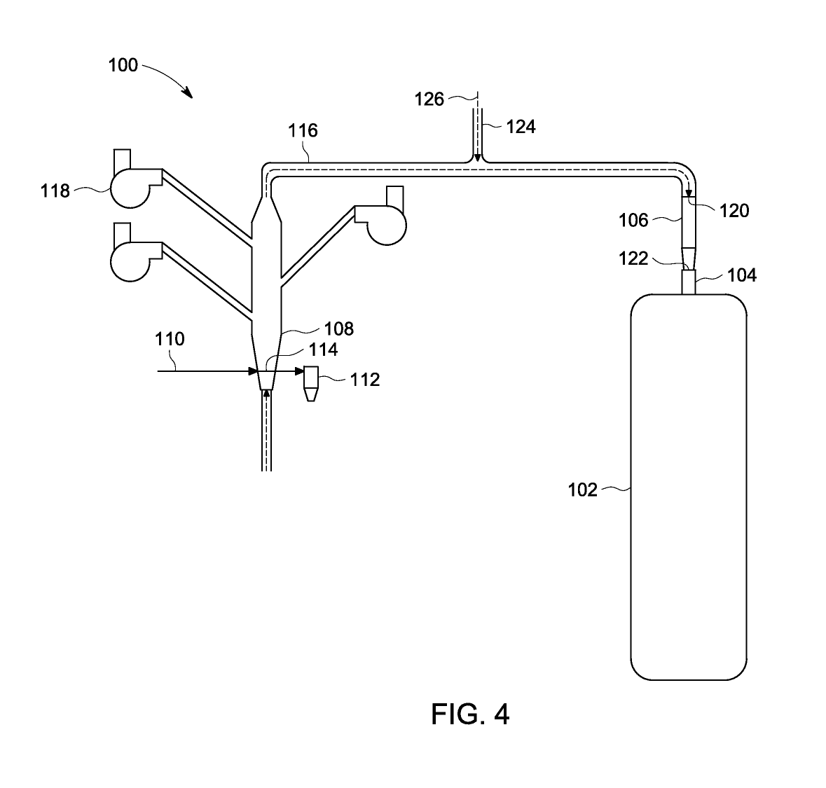

FIG. 4 illustrates another embodiment of the feed transporting and injection system 100 in which the transition vessel is installed near the top of the gasifier 102. This embodiment is useful where the solid fuel particles are transported to the injector 104 through a short pipeline to minimized instability or blockage during conveyance. The system 100 includes an auxiliary transition vessel 106 in addition to the transition vessel 108, purge gas line 110, discharge hopper 112, distributor 114, and outlet pipeline 116, solid pumps 118 that have same configuration as the embodiment described previously with respect to FIG. 1. The auxiliary transition vessel 106 can be directly connected to a gasifier injector 104. The auxiliary transition vessel 106 is scaled-down version of the transition vessel 108 and includes an inlet 120 connected to the outlet pipeline 116 and an outlet 122 connected to the injector. The system 100 further includes a supplemental gas line 124 connected to the outlet pipeline 116 between the transition vessel 108 and the auxiliary transition vessel 106. A supplemental gas 126 is delivered through the supplemental gas line 124 to stabilize the flow of feed to the gasifier 102. Supplemental gas line 124 can be connected to the pipeline 116 with certain angles or by using some special design (not shown) such as a gas distributor, porous media or a Venturi. The volume of the auxiliary transition vessel is 5˜20 times smaller than that of the transition vessel 16, i.e., the solid particle residence time in the auxiliary transition vessel is in the range of 0.5˜10 seconds.

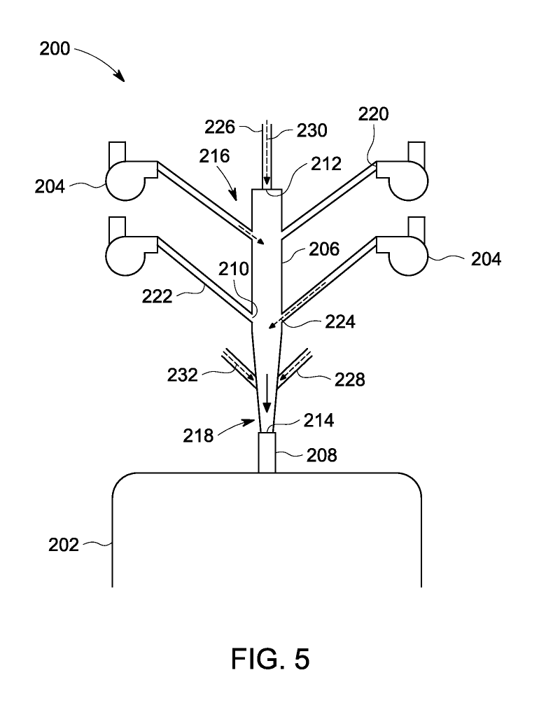

FIG. 5 illustrates another embodiment of the system 200 for transporting and injecting fuel to a gasifier 202. The system 200 includes a plurality of solid pumps 204 and a high-pressure transition vessel 206 that is connected to an injector 208 of the gasifier. The transition vessel 206 includes first inlets 210, a second inlet 212, and an outlet 214. The first inlets 210 are located on the sidewall of the transition vessel 206 and are between the top portion 216 and the bottom portion 218 of the transition vessel 206. The outlets 220 of solid pumps 204 are directly connected to the first inlets 210 using declining pipelines 222 so that all of the fuel 224 delivered by the solid pumps 204 pass through the transition vessel 206. In one embodiment, the first inlets 210 are at different levels of the transition vessel 206 to enable connection of multiple solid pumps 204.

In this embodiment, the second inlet 212 is at a top portion 216 of the transition vessel 206 and is connected to a conveyance gas line 226. The outlet 214 is at a bottom portion 218 of the transition vessel 206. The outlet 214 of the transition vessel is connected directly to the injector 208. The system 200 further comprises supplemental gas lines 228 connected to the transition vessel 206. The supplemental gas lines 228 are downstream of the first inlets 210.

The conveyance gas 230 from the conveyance gas line 226 enters the transition vessel 206 through the second inlet 212 and carries the solid particulate fuel 224 to the injector 208 through the outlet 214. For some high moisture fuel particles, the outlet 214 may be blocked. The supplemental gas 232 delivered through the supplemental gas line 228 can be utilized to facilitate smooth discharge of solid fuel particles through the outlet 214. Supplemental gas line 228 can be connected to the transition unit 206 with different angles through different designs (not shown) including gas distributor, porous plate or Venturi.

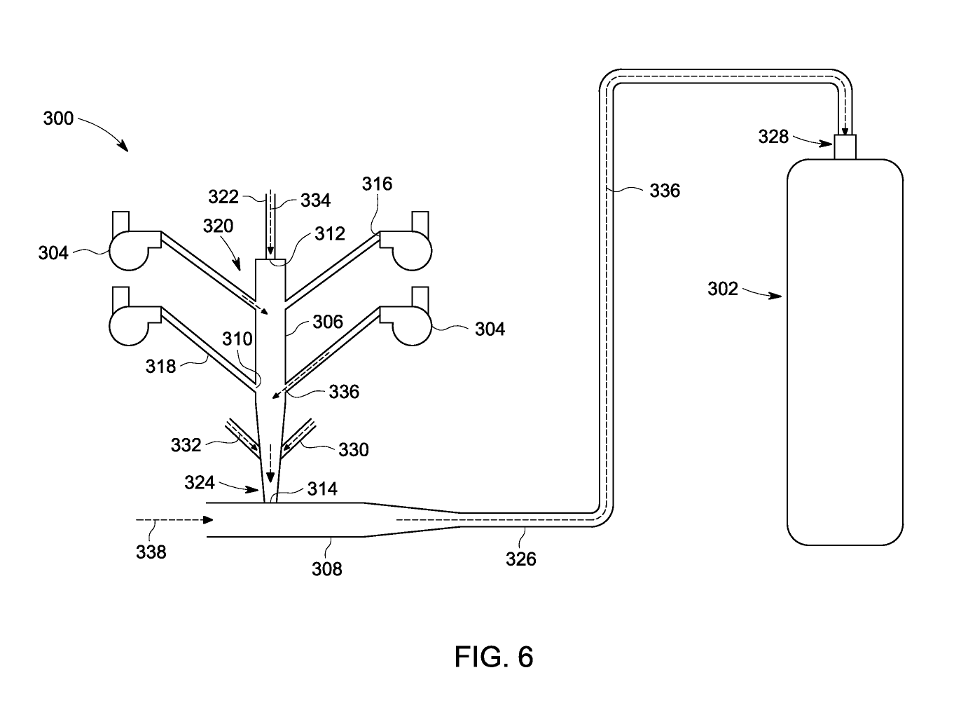

FIG. 6 illustrates another embodiment of the system 300 for transporting and injecting fuel to a gasifier 302. The system 300 includes a plurality of solid pumps 304, a high-pressure transition vessel 306, and a feeder 308. The transition vessel 306 includes first inlets 310 on its sidewall, a second inlet 312, and an outlet 314. The outlets 316 of solid pumps are directly connected to the first inlets 308 using declining pipelines 318. The second inlet 312 is at a top portion 320 of the transition vessel 306 and is connected to a conveyance gas line 322. The outlet 314 is at a bottom portion 324 of the transition vessel 306. The feeder 308 is connected to the outlet 314 of the transition vessel 306. An outlet pipeline 326 connects the feeder 308 to an injection system 328 of the gasifier 302. The system 300 further comprises supplemental gas lines 330 connected to the transition vessel 306, downstream of the first inlets 310 and before the feeder 308 to deliver supplemental gas 332.

The conveyance gas 334 from the conveyance gas line 322 enters the transition vessel 306 through the second inlet 312 and carries the solid particulate fuel 336 to the feeder 308 through the outlet 314. The fuel 336 is then transported to the injector 328 through the outlet pipeline 326. Conveyance gas 338 is also provided to the feeder 308 to transport the fuel 336 to the injector 328. To ensure the smooth solid flow in the feeder 308, conveyance gas 338 can be introduced into the feeder with different designs (not shown) such as a gas distributor, or a porous plate. Furthermore, a fluidizing gas (not shown) can also be introduced to horizontal feeder 308.

The systems for transporting and injecting fuel to a gasifier described above thus provide a way to smoothly and stably transport solid fuel particles with high moisture content to a gasifier from solid pumps and enhance carbon conversion. The flow pattern is converted from the loose drop flow to the entrained flow and fed into the gasifier with high concentration. Employing the transition vessel can eliminate negative effects such as block, plug-in, and rat holing. Since the transition unit has a small volume, the solid flow in the system is in the transport flow regime, solid pumps can easily control the solid flow rate, especially for turn-up and turndown operations. Also, solid particulate fuel, i.e. dry feedstock, and slurry are injected into the gasifier through different injectors, leading to a better mixing in the gasifier. Different residence times are achieved for smaller and larger particles to enhance carbon conversion.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for use in a gasification system, comprising:
a solid pump that delivers a pressurized solid fuel; and
a high-pressure transition vessel, comprising:
a first inlet connected to an outlet of the solid pump so that all of the fuel from the solid pump passes through the transition vessel;
a second inlet for connection to a conveyance gas line; and
an outlet through which the fuel is transported to a gasifier,
wherein the transition vessel is elongated in the direction of a flow so that a conveyance gas introduced through said conveyance gas line carries the fuel delivered by the solid pump to the gasifier when the fuel enters the transition vessel.

2. The system of claim 1, wherein the second inlet is at a bottom portion of the transition vessel, the outlet is at a top portion of the transition vessel, and the first inlet is between the top portion and the bottom portion.

3. The system of claim 2, further comprises a distributor in the transition vessel.

4. The system of claim 3, further comprises a purge gas line and a discharge hopper, wherein the purge gas line is in flow communication with the distributor and the discharge hopper to transfer undelivered fuel from the distributor to the discharge hopper.

5. The system of claim 2, wherein the outlet of the transition vessel is connected to an outlet pipeline through which the solid fuel is transported to the gasifier.

6. The system of claim 5, further comprises a supplemental gas line connected to the outlet pipeline.

7. The system of claim 5, further comprises an auxiliary transition vessel comprising an inlet connected to the outlet pipeline and an outlet connected to an injection system of the gasifier.

8. The system of claim 1, wherein the second inlet is at a top portion of the transition vessel, the outlet is at a bottom portion of the transition vessel, and the first inlet is between the top portion and the bottom portion.

9. The system of claim 8, wherein the outlet of the transition vessel is connected directly to an injection system of the gasifier.

10. The system of claim 8, further comprises a supplemental gas line connected to the transition vessel, downstream of the first inlet

11. The system of claim 8, further comprises a feeder connected to the outlet of the transition vessel and an outlet pipeline connecting the feeder to an injection system of the gasifier.

12. The system of claim 1, further comprises an injection system comprising a slurry injector and a plurality of solid feed injectors, wherein the fuel from the transition vessel is transported to the feed injectors.

13. The system of claim 12, wherein the solid feed injectors are installed on the gasifier, symmetrically with respect to an axis of the gasifier.

14. The system of claim 13, wherein the feed injectors are perpendicular to the wall of the gasifier.

15. The system of claim 13, wherein the feed injectors are at an oblique angle with respected to the wall of the gasifier

16. The system of claim 12, wherein each of the feed injectors comprises a central channel for conveying the fuel and a swirl channel.

17. The system of claim 12, wherein the slurry injector is installed at a top portion of the gasifier and the feed injectors are installed symmetrically around a sidewall of the gasifier.

18. The system of claim 12, wherein the fuel comprises a solid particulate fuel.

19. A system for use in a gasification system, comprising:
a plurality of solid pumps that deliver a pressurized solid particulate fuel; and
a high-pressure transition vessel, comprising:
a plurality of first inlets, wherein each of the first inlets is connected to an outlet of the solid pump so that all of the solid particulate fuel from the solid pumps passes through the transition vessel;
a second inlet for connection to a conveyance gas line; and
an outlet through which the fuel is transported to an injection system of a gasifier,
wherein the transition vessel is elongated in the direction of a flow so that a conveyance gas introduced through said conveyance gas line carries the fuel delivered by the solid pump to the gasifier when the fuel enters the transition vessel.

20. The system of claim 19, wherein the first inlets are at different levels of the transition vessel.

21. The system of claim 19, wherein the second inlet is at a bottom portion of the transition vessel, the outlet is at a top portion of the transition vessel, and the first inlets are between the top portion and the bottom portion.

22. The system of claim 20, further comprises a distributor in the transition vessel, a purge gas line, and a discharge hopper, wherein the purge gas line is in flow communication with the distributor and the discharge hopper to transfer undelivered fuel from the distributor to the discharge hopper.

23. The system of claim 19, wherein the second inlet is at a top portion of the transition vessel, the outlet is at a bottom portion of the transition vessel, and the first inlets are between the top portion and the bottom portion.

24. The system of claim 23, wherein the outlet of the transition vessel is connected directly to the injection system.

25. The system of claim 23, further comprises a feeder connected to the outlet of the transition vessel and an outlet pipeline connecting the feeder to the injection system.

26. The system of claim 19, wherein the injection system comprises a slurry injector installed at a top portion of the gasifier and a plurality of feed injectors installed symmetrically around a sidewall of the gasifier, wherein the fuel from the transition vessel is transported to the feed injectors.

27. A system for use in a gasification system, comprising:
an injection system for a gasifier, comprising a slurry injector and a plurality of solid feed injectors;
a plurality of solid pumps that deliver a pressurized solid particulate fuel; and
a high-pressure transition vessel, comprising:
a plurality of first inlets, wherein each of the first inlets is connected directly to an outlet of the solid pump so that all of the solid particulate fuel from the solid pumps passes through the transition vessel;
a second inlet for direct connection to a conveyance gas line; and
an outlet through which the fuel is transported to the feed injectors,
wherein the transition vessel is elongated in the direction of a flow so that a conveyance gas introduced through said conveyance gas line carries the fuel delivered by the solid pump to the gasifier when the fuel enters the transition vessel.
